(19) United States
(12) Patent Application Publication
(10) Pub. No.: US 2026/0000174 A1
(43) Pub. Date: Jan. 1, 2026

(54) Luggage with a Customized Accommodating Cavity for Multifunctional Electronic Objects

(71) Applicant: Li Zhijian, Fuzhou (CN)

(72) Inventor: Li Zhijian, Fuzhou (CN)

(21) Appl. No.: 19/323,053

(22) Filed: Sep. 9, 2025

Related U.S. Application Data
(63) Continuation-in-part of application No. 18/225,708, filed on Jul. 25, 2023.
Application No. 18/225,708 is a continuation-in-part of application No. 16/608,232, filed on Oct. 25, 2019, now Pat. No. 12,004,617.
(60) Provisional application No. 63/692,670, filed on Sep. 9, 2024.

(30) Foreign Application Priority Data
Apr. 27, 2017 (CN) 201710287785.9

(51) Int. Cl. A45C 13/28; A45C 5/03; A45C 5/14; A45C 13/26; H01M 50/247; H01M 50/262

(52) U.S. Cl. CPC A45C 13/28; A45C 5/03; A45C 5/14; A45C 13/262; H01M 50/247; H01M 50/262; A45C 2013/267; H01M 2220/30

(57) ABSTRACT

A bag includes a body, and a pull rod frame mounted on a portion of the body, the pull rod frame comprising first and second pull rods. A cavity is defined within the body. A case is configured to fit within the cavity and be selectively removable from the cavity. The case can include at least one electronic chip such as: a crowdsourced wireless Bluetooth network location chip; an ultra-wideband (UWB) location chip; a cellular communication chip; a global positioning satellite (GPS) chip; a MiFi (wireless router mobile hotspot) chip; a near field communication (NFC) wireless chip.

### CROSS-REFERENCE TO RELATED APPLICATION

This application is a continuation-in-part of U.S. application Ser. No. 18/225,708 filed Jul. 25, 2023, which is a continuation-in-part of U.S. application Ser. No. 16/608,232 filed Oct. 25, 2019, now U.S. Pat. No. 12,004,617 issued Jun. 11, 2024, which is a 371 U.S. national phase entry of PCT/CN2018/082916 filed Apr. 13, 2018, which claims priority to Chinese application No. 201710287785.9 filed Apr. 27, 2017, and the entire disclosure of each said prior application is hereby expressly incorporated by reference into the present specification. This application also claims priority from and benefit of the filing date of U.S. provisional application Ser. No. 63/692,670 filed Sep. 9, 2024, and the entire disclosure of said provisional application is hereby expressly incorporated by reference into the present specification.

### TECHNICAL FIELD

The present invention relates to the technical field of trolley cases, in particular to a trolley case with a charging device.

### BACKGROUND OF THE INVENTION

The common trolley case in the market usually only has the simple function of storing luggage. People put all their luggage therein when they take the trolley case for travel or business trip. However, with the more and more frequent use of electronic equipment, the demand of electronic equipment for power supply is increasing. If you go out for a long time, the mobile phone you carry will need to be charged from time to time. Now there are mobile power supplies such as Charge Pal to realize real-time charging function. However, when people go out, Charge Pal can only be placed in the trunk, resulting in the need to take out the Charge Pal from the trunk to charge the mobile phone, thus wasting time. Moreover, it is very inconvenient to take the Charge Pal out of the trunk when checking.

### SUMMARY OF THE INVENTION

One purpose of the present invention is to provide a trolley case with a charging device, which is convenient to take the charging device at any time due to the storage position of the external charging device, and the sliding cover arrangement makes the charging device difficult to fall out.

The technical scheme adopted by the present invention is as follows: a trolley case with a charging device comprises a case body, a pull rod frame mounted on the case body and a traveling wheel mechanism installed at the bottom of the case body; the pull rod frame is provided with a telescopic pull rod used for dragging the case body, the pull rod frame is provided with a charger accommodating cavity positioned in the middle of the pull rod and used for placing a charging device, the upper part of the charger accommodating cavity is provided with an opening, sliding chutes are arranged on both sides of the opening, and a sliding cover used to cover or open the opening is slidably arranged in the sliding chutes.

Further, in order to fasten the sliding cover, elastic lugs are arranged on both sides of the sliding cover, and protrusions matched with the elastic lugs for limiting and locking the sliding cover are arranged on the inner side of the inner wall of the sliding chutes, The outer side of the inner wall of the sliding chute is provided with a lug for preventing the sliding cover from completely sliding out of the sliding chute, and the outer side of the sliding cover is provided with an arc-shaped protrusion for pulling the sliding cover,

Further, the setting of the spring is convenient to take the charging device, and the charger accommodating cavity can therefore be adapted to charging devices of various specifications, and the specifications of the charging device are proportional to the compression deformation of the spring; the bottom of the charger accommodating cavity is provided with an elastic piece accommodating cavity for installing an elastic piece, and a spring for ejecting the charging device is arranged in the elastic piece accommodating cavity.

Further, in order to prevent the charging device from being impacted, buffer foam for preventing the charging device from being impacted is mounted on the inner wall of the charger accommodating cavity.

Further, umbrellas usually cannot be checked in during customs luggage inspection, so umbrellas are usually stored separately. To provide a cavity for storing umbrellas, the case body is provided with an umbrella groove for placing umbrellas,

Further, in order to provide charging convenience in a state where the sliding cover is closed, the sliding cover is provided with a charging port which is used for inserting a USB connector. When charging, the mobile phone can also be placed in the umbrella slot, which is more convenient.

Further, in order for the traveling wheel to move by itself, the traveling wheel mechanism comprises a front traveling wheel set arranged at both ends of the front side of the bottom of the case body and a rear traveling wheel set arranged at both ends of the rear side of the bottom of the case body, the rear traveling wheel set is provided with a driving mechanism for driving the rear traveling wheel set to roll, and the driving mechanism is connected with a button arranged on the case body for controlling the switch thereof.

Further, in order to drive the rear traveling wheel set to move, the front traveling wheel set is a universal wheel, the rear traveling wheel set is a directional wheel, the rear traveling wheel set comprises two rear traveling wheels respectively arranged at two ends of the rear side of the case body and a rotating shaft fixedly connected with the two rear traveling wheels, a connecting shaft is fixedly arranged at the bottom of the case body, the lower end of the connecting shaft is connected with the rotating shaft through a bearing, the rotating shaft is coaxially provided with a first sprocket, the driving mechanism comprises a driving motor arranged at the bottom of the case body and an output sprocket arranged on the driving motor, and the output sprocket is rotatably connected with the first sprocket to drive the first sprocket to rotate so as to drive the rear traveling wheel to roll.

Further, in order to realize the self-generating function, a micro generator is arranged at the bottom of the trolley case, and the micro generator is electrically connected with the charging device so as to store electric energy in the charging device; the rotating shaft is also coaxially provided with a second sprocket, the micro generator is provided with an input sprocket, and the second sprocket is rotatably connected with the input sprocket to drive the input sprocket to rotate so as to drive the micro generator to generate electricity.

Further, in order to provide the luggage weight measurement function, the trolley case also comprises a pressure sensor for measuring the weight of the trolley case, a controller and a display, wherein the pressure sensor is electrically connected with the controller for transmitting pressure signals to the controller, and the controller is electrically connected with the display for displaying the pressure signals received from the pressure sensor. The middle of the bottom of the case body is rotatably provided with a measuring block, the pressure sensor is installed on the measuring block, the height of the measuring block is higher than the height of the traveling wheel mechanism so as to facilitate the traveling wheel mechanism to leave the ground when the measuring block is folded down.

In order to facilitate quick recovery when luggage is lost, a GPS positioning module is also arranged in the case body.

In accordance with one aspect of the present development, bag includes a body, and a pull rod frame mounted on a portion of the body, the pull rod frame comprising first and second pull rods. A cavity is defined within the body. A case is configured to fit within the cavity and be selectively removable from the cavity. The case can include at least one electronic chip such as: a crowdsourced wireless Bluetooth network location chip; an ultra-wideband (UWB) location chip; a cellular communication chip; a global positioning satellite (GPS) chip; a MiFi (wireless router mobile hotspot) chip; a near field communication (NFC) wireless chip.

Compared with the prior art, the present invention has the following advantages: (1) The separate storage position of the external charging device of the present invention is convenient to take the charging device at any time, and the sliding cover arrangement makes the charging device difficult to fall out; (2) The spring in the present invention can eject the charging device and can make the charger accommodating cavity adapted to charging devices of various specifications, the specifications of the charging device are proportional to the compression deformation of the spring, the larger the charging device is, the more greatly the spring is compressed, and the smaller the charging device is, the more slightly the spring is compressed; (3) According to the present invention, a pressure sensor is arranged to provide a luggage weight measurement function, and a traveling wheel mechanism with a driving mechanism is arranged to realize the self-moving of the trolley case.

### BRIEF DESCRIPTION OF THE DRAWINGS

The development is further described with reference to drawings and embodiments:

FIG. 1 is a schematic structural diagram of the present invention;

FIG. 2 is a schematic structural diagram of the pull rod frame;

FIG. 3 is a schematic diagram of the connection between the sliding cover and the sliding chutes;

FIG. 4 is a schematic structural diagram of the charger accommodating cavity;

FIG. 5 is a schematic structural diagram of the measuring block;

FIGS. 6, 7, 8, 9, 10, 11, 12, 13, 14, 15, 16, 17, 18, 19, 20, 21, 22, 23, 24, 25, 26, 27, 28, 2 9, 30, 31, 32, 33, 34, 35, 36, 37, 38, 39, 40, 41, 42, 43 and 44 depict aspects of the present invention.

FIGS. 45A-45E show schematic structural diagram of a piece of luggage showing a cavity and a case to fit within the cavity.

FIGS. 46A-46B show another embodiment of the piece of luggage and the case shown in FIGS. 45A-E,

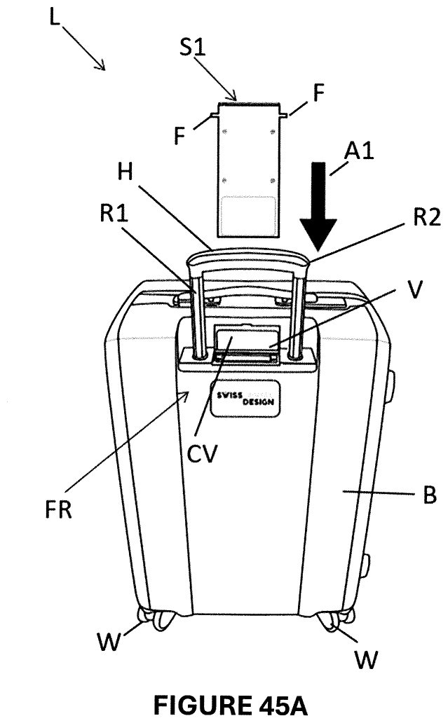

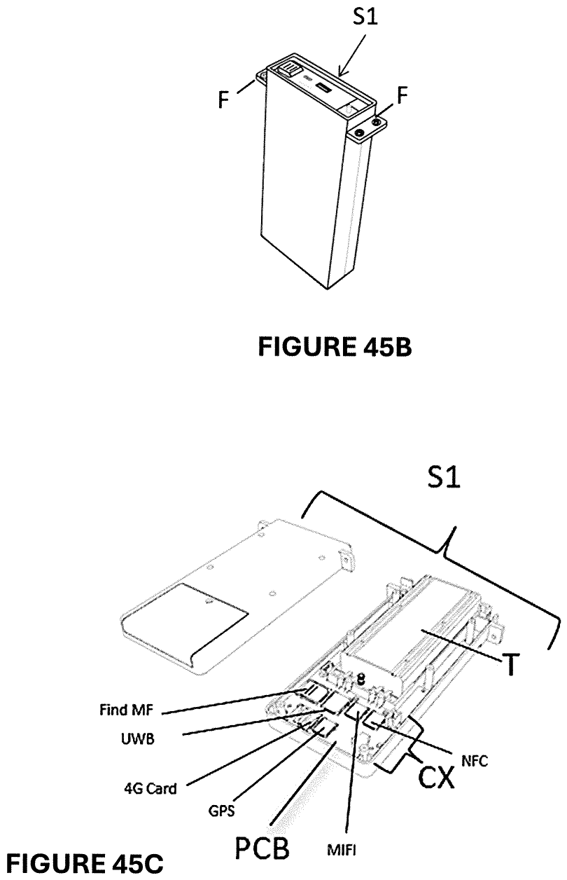

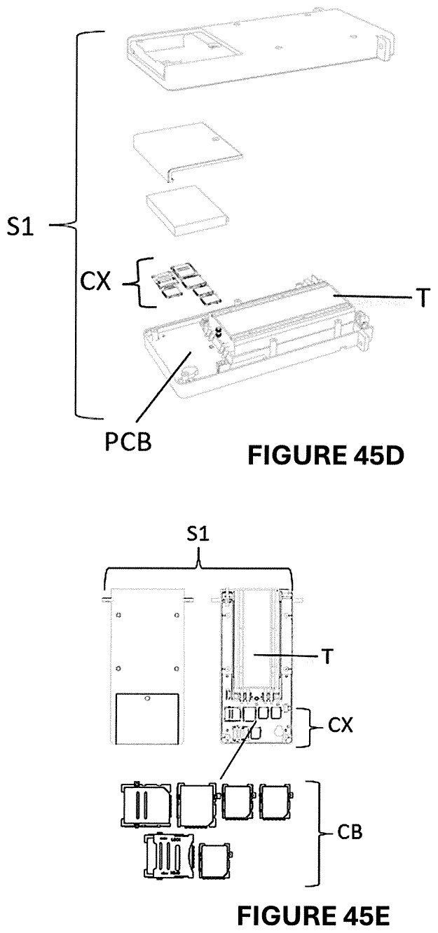

FIGS, 47A-47B show another embodiment of the piece of luggage and the case shown in FIGS. 45A-E.

### DETAILED DESCRIPTION OF THE EMBODIMENTS

The following is a detailed description of the present invention with reference to the drawings attached to the specification and specific embodiment. In the diagrams: 1—case body; 2—front traveling wheel set: 3—rear traveling wheel set; 4—umbrella groove; 5—pull rod frame; 501—pull rod; 502—sliding cover; 5021—elastic lug; 5022—arc-shaped protrusion; 503—charger accommodating cavity; 504—elastic piece accommodating cavity; 505—charging port, 506—sliding chutes; 5061—protrusion; 5062—lug; 507—buffer foam; 508—spring; 6—display; 7—measuring block; 8—pressure sensor, 9—micro generator.

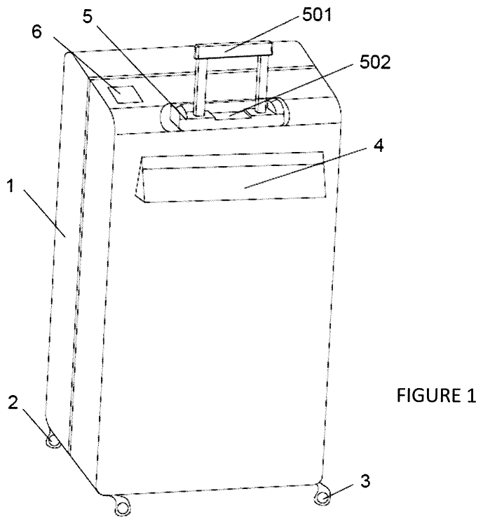

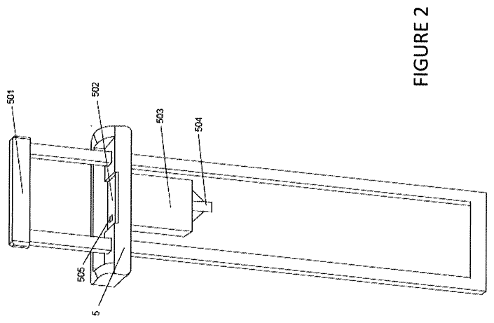

As shown in FIGS. 1-5, this embodiment provides a trolley case with a charging device, which comprises a case body 1, a pull rod frame 5 mounted on the case body 1 and a traveling wheel mechanism installed at the bottom of the case body 1; the pull rod frame 5 is provided with a telescopic pull rod 501 used for dragging the case body 1, the pull rod frame 5 is provided with a charger accommodating cavity 503 positioned in the middle of the pull rod 501 and used for placing a charging device, the upper part of the charger accommodating cavity 503 is provided with an opening, sliding chutes 506 are arranged on both sides of the opening, and a sliding cover 502 used to cover or open the opening is slidably arranged in the sliding chutes 506.

In this embodiment, in order to fasten the sliding cover 502, elastic lugs 5021 are arranged on both sides of the sliding cover 502, and protrusions 5061 matched with the elastic lugs 5021 for limiting and locking the sliding cover 502 are arranged on the inner side of the inner wall of the sliding chutes 506, The outer side of the inner wall of the sliding chute 506 is provided with a lug 5062 matched with the elastic protrusions 5021 for preventing the sliding cover 502 from completely sliding out of the sliding chute 506, and the outer side of the sliding cover 502 is provided with an arc-shaped protrusion 5022 for pulling the sliding cover 502.

In this embodiment, the setting of the spring 508 is convenient to take the charging device, and the charger accommodating cavity 503 can therefore be adapted to charging devices of various specifications. The specifications of the charging device are proportional to the compression deformation of the spring 508. The bottom of the charger accommodating cavity 503 is provided with an elastic piece accommodating cavity 504 for installing an elastic piece, and a spring 508 for ejecting the charging device is arranged in the elastic piece accommodating cavity 504.

In this embodiment, in order to prevent the charging device from being impacted, buffer foam 507 for preventing the charging device from being impacted is mounted on the inner wall of the charger accommodating cavity 503.

In this embodiment, umbrellas usually cannot be checked in during customs luggage inspection, so umbrellas are usually stored separately. To provide a cavity for storing umbrellas, the case body 1 is provided with an umbrella groove 4 for placing umbrellas.

In this embodiment, in order to provide charging convenience in a state where the sliding cover 502 is closed, the sliding cover 502 is provided with a charging port 505 which is used for inserting a USB connector. When charging, the mobile phone can also be placed in the umbrella slot 4, which is more convenient. The sliding cover 502 is also provided with a charging hole for inserting a charging wire to facilitate charging the charging device.

In this embodiment, in order for the traveling wheel to move by itself, the traveling wheel mechanism comprises a front traveling wheel set 2 arranged at both ends of the front side of the bottom of the case body 1 and a rear traveling wheel set 3 arranged at both ends of the rear side of the bottom of the case body 1, the rear traveling wheel set 3 is provided with a driving mechanism for driving the rear traveling wheel set 3 to roll, and the driving mechanism is connected with a button arranged on the case body 1 for controlling the switch thereof. When in use, the button is pressed, the driving mechanism starts to work, the rear traveling wheel set 3 is driven to rotate, and the trolley case moves by itself.

In this embodiment, in order to drive the rear traveling wheel set 3 to move, the front traveling wheel set 2 is a universal wheel, the rear traveling wheel set 3 is a directional wheel, the rear traveling wheel set 3 comprises two rear traveling wheels respectively arranged at two ends of the rear side of the case body 1 and a rotating shaft fixedly connected with the two rear traveling wheels, a connecting shaft is fixedly arranged at the bottom of the case body 1, the lower end of the connecting shaft is connected with the rotating shaft through a bearing, the rotating shaft is coaxially provided with a first sprocket, the driving mechanism comprises a driving motor arranged at the bottom of the case body 1 and an output sprocket arranged on the driving motor, and the output sprocket is rotatably connected with the first sprocket to drive the first sprocket to rotate so as to drive the rear traveling wheel to roll.

In this embodiment, in order to realize the self-generating function, a micro generator is arranged at the bottom of the case body 1, and the micro generator is electrically connected with the charging device so as to store electric energy in the charging device; the rotating shaft is also coaxially provided with a second sprocket, the micro generator is provided with an input sprocket, and the second sprocket is rotatably connected with the input sprocket to drive the input sprocket to rotate so as to drive the micro generator to generate electricity.

In this embodiment, in order to provide the luggage weight measurement function, the trolley case further comprises a pressure sensor 8 for measuring the weight of the trolley case, a controller and a display 6, wherein the pressure sensor 8 is electrically connected with the controller for transmitting pressure signals to the controller, and the controller is electrically connected with the display 6 for displaying the pressure signals received from the pressure sensor 8. The middle of the bottom of the case body 1 is rotatably provided with a measuring block 7, the pressure sensor 8 is installed on the measuring block 7, the height of the measuring block 7 is higher than the height of the traveling wheel mechanism so as to facilitate the traveling wheel mechanism to leave the ground when the measuring block 7 is folded down, and the display 6 is arranged on the case body 1.

In this embodiment, in order to facilitate quick recovery when luggage is lost, a GPS positioning module is also arranged in the case body 1.

In this embodiment, when in use, the Charge Pal is directly put into the charger accommodating cavity 503. The spring 508 of the elastic piece accommodating cavity 504 can automatically adjust the size of the elastic piece accommodating cavity 504 according to the size of the Charge Pal to adapt to the Charge Pal. After the Charge Pal is placed, the sliding cover 502 is covered, and the elastic lug 5021 is matched with the protrusion 5061, so that the sliding cover 502 is closed tightly, and the buffer foam 507 can be buffered to reduce the vibration generated when the trolley case moves,

A trolley case with a charging device, a case body, a pull rod frame mounted on the case body (1) and a traveling wheel mechanism installed at the bottom of the case body (1), the pull rod (501) frame is provided with a telescopic pull rod used for dragging the case body, the pull rod frame is provided with a charger accommodating cavity (78) positioned in the middle of the pull rod and used for placing a charging device, wherein an upper part of the charger accommodating cavity has an opening with an upper closing device, wherein the opening and the upper closing device have a male component (1100) and a female component (1102).

The upper closing device has a raised strip (60) and a top part of the accommodating cavity body has a corresponding recessed space (76) to receive the raised strip sealing the gap between the upper closing device and the accommodating cavity body, A top part of the charger accommodating cavity may have a raised strip and the upper closing device has a corresponding recessed space to receive the strip sealing the gap between the upper closing device and the accommodation cavity body. The upper closing device may have a raised rubber portion and a corresponding area of a lower part of the accommodating cavity has a recess.

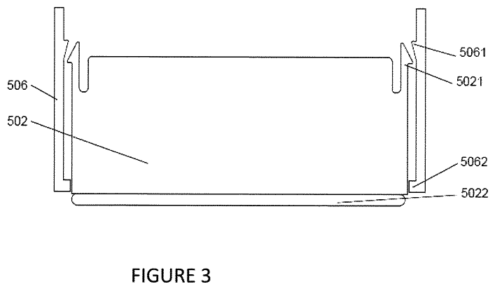

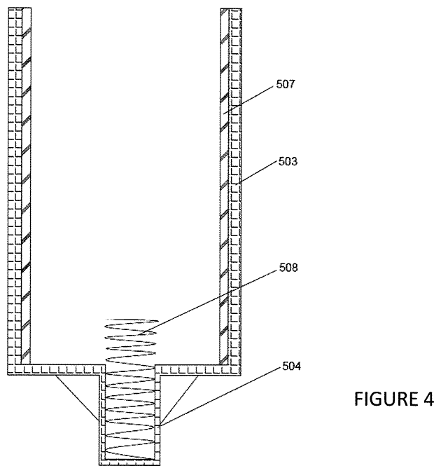

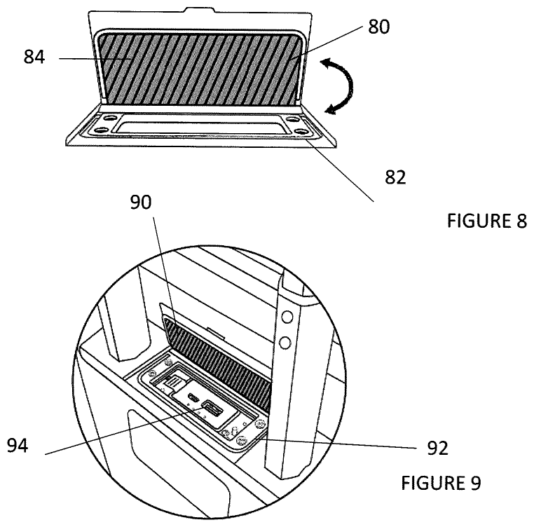

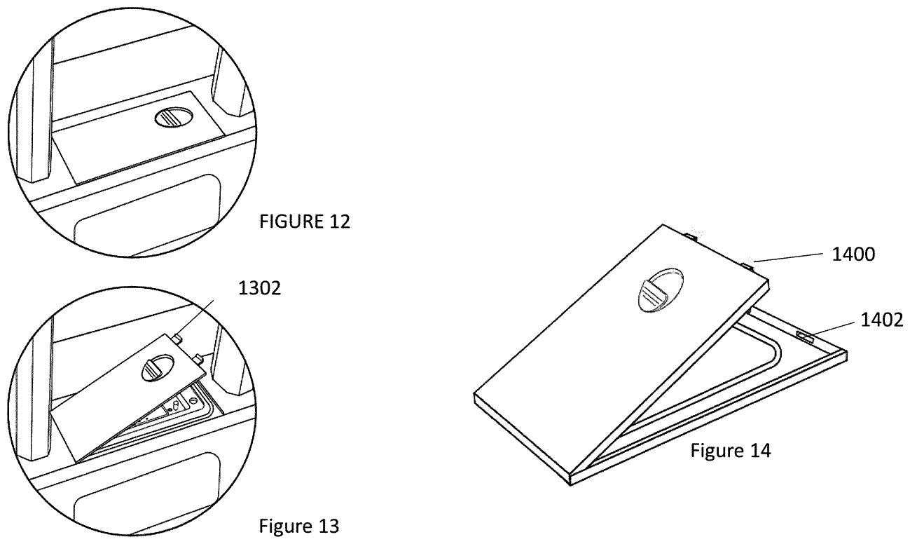

As shown in FIGS. 12, 13 and 14, the upper part has a female part of a slotted opening and the upper closing device has a male part of an activity tongue, as shown in FIGS. 3-12. The upper closing device has a button (1404), wherein the button (1404) can be moved and when the button is moved in the opposite direction to an original state, the male part (1400) releases the female part (1402) and the upper closing device is opened and when the upper closing device is closed the male part resets tightly to the female part of the component to tightly fix together and the button returns to its original position, as shown in FIGS. 4, 5, 6, and 7.

The upper closing device has a female part of a slot and a corresponding movable L shaped cover plate with a male part (1302) on the upper part of the charger accommodating cavity body when the L shaped cover plate is opened, the upper closing device automatically pops up, when stuck on the L shaped cover plate it provides a closed seal, as shown in FIG. 13.

The male part on the upper closing device has a gripped catch and the female part on the upper part of the charger accommodating cavity body has a movable release and grip fastener and a spring-loaded control element that controls the release or grip of the fastener by pressing, as shown in FIG. 14. As shown in FIG. 30, there may be a connecting belt (3000) connecting the upper closing device and the charger accommodating cavity body to prevent the upper closing device from falling off after opening the cover. There may be an elastic piece accommodating cavity for installing an elastic piece is arranged at the bottom of the charger accommodating cavity, and a spring for ejecting the charging device is arranged in the elastic piece accommodating cavity. There may be a buffer foam (84) mounted on the inner wall of the charger accommodating cavity. There may be a charging port (94) under the cover. The upper closing device may be opened by flip, sliding and pop-up mechanism,

The traveling wheel mechanism may have a front traveling wheel set arranged at both ends of the front side of the bottom of the case body and a rear traveling wheel set arranged at both ends of the rear side of the bottom of the case body, wherein the rear traveling wheel set is provided with a driving mechanism for driving the rear traveling wheel set to roll, and the driving mechanism is connected with a button arranged on the case body for controlling a switch.

There may be a micro generator (9) at the bottom of the case body, wherein the micro generator is electrically connected with the charging device to store electric energy in the charging device and the rotating shaft is coaxially provided with a second sprocket, the micro generator is provided with an input sprocket, and the second sprocket is rotatably connected with the input sprocket to drive the input sprocket to rotate so as to drive the micro generator to generate electricity.

The trolley case may further comprise a pressure sensor (8) along a bottom portion of the case body for measuring the weight of the trolley case, a controller and a display along a top portion of the case body, the pressure sensor is electrically connected with the controller for transmitting pressure signals to the controller, and the controller is electrically connected with the display for displaying the pressure signals received from the pressure sensor. A middle portion of the bottom of the case body is rotatably provided with a measuring block (7), a pressure sensor (8) is installed on the measuring block (7), the height of the measuring block is higher than the height of the traveling wheel mechanism and a display is arranged on the case body,

A trolley case with electronic objects with batteries having a case body, a pull rod frame mounted on the case body and a traveling wheel mechanism installed at the bottom of the case body: the pull rod frame is provided with a telescopic pull rod used for dragging the case body, the pull rod frame is provided with an electronic objects storage accommodating cavity positioned in the middle of the pull rod and used for placing an electronic objects, the upper part of the electronic objects storage accommodating cavity has an opening with an upper closing device, the upper part of the electronic objects storage accommodating cavity body opening and the upper closing device are made up of a set of male and female structural components to achieve a tight closure, configured to firmly close the opening to protect the charger accommodating cavity to reach a water resistant, dust resistant and moisture-proof performance structure.

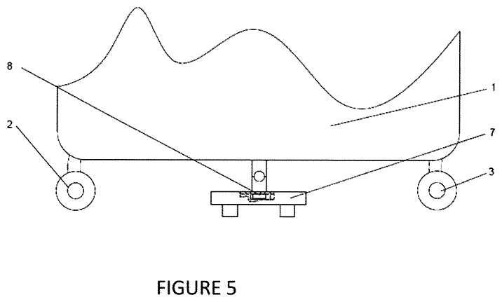

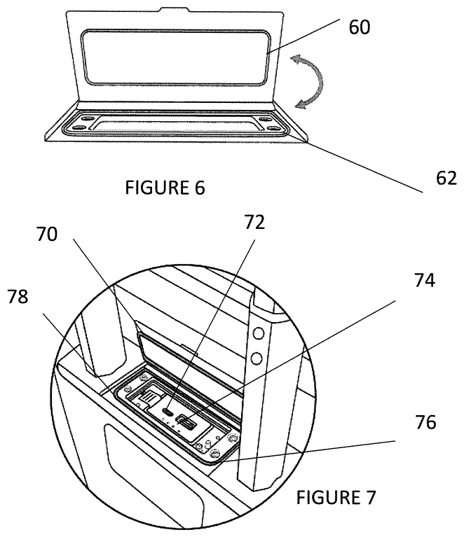

As shown in FIGS. 6 and 7, the upper closing device has a raised strip (60) and the top part of the accommodating cavity body has a corresponding space (76) to receive the strip, to seal the gap between the upper closing device and the accommodation cavity body, to play a water resistant and dust resistant effect. The top part of the accommodating cavity body has a raised strip, and the upper closing device has a corresponding recesses space to receive the strip, to seal the gap between the upper closing device and the accommodation cavity body, to improve water resistant and dust resistant effect.

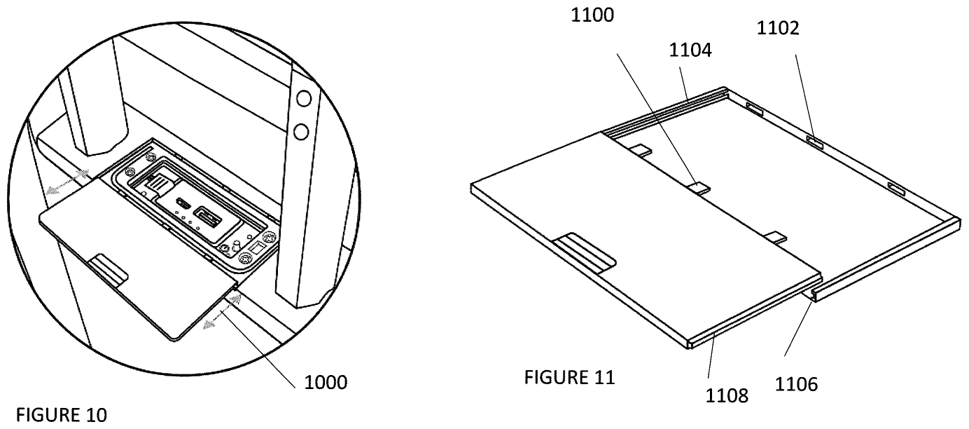

As shown in FIGS. 10 and 11, an upper closing device in the form of a sliding cover, there are track slots (1104, 1106) on the left and right sides of the body, corresponding tracks (1108) on the left and right sides of the cover, sockets on the bottom of the main body, and pins corresponding to the cover, the cover can be opened when sliding the cover outward, and the cover can be closed when sliding it inward, wherein the upper part of the charger accommodating cavity body opening and the upper closing device are made up of a set of male (1100) and female (1102) structural components to achieve a tight closure, configured to firmly close the opening to protect the charger accommodating cavity to reach a water resistant, dust resistant and moisture-proof performance structure.

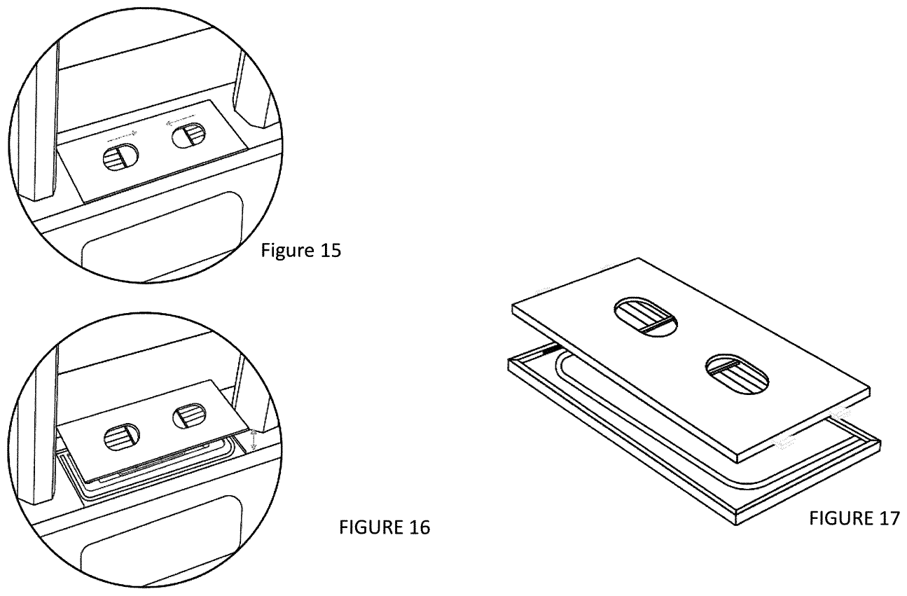

As shown in FIGS. 15, 16 and 17, The upper part of the charger accommodating cavity body opening is designed with a female part of components i.e. a slotted opening, upper closing device is designed with a male part of components i.e. a retractable tongue. The upper closing device has a button, the button can be toggled left and right and when the button is toggled inward, the male part of components retracts internally and the upper closing device can be opened or popped up, conversely, when the upper closing device is closed, the male part of component pops outward and tightly unites with the female part of component, and the button on the upper closing device returns to its original position.

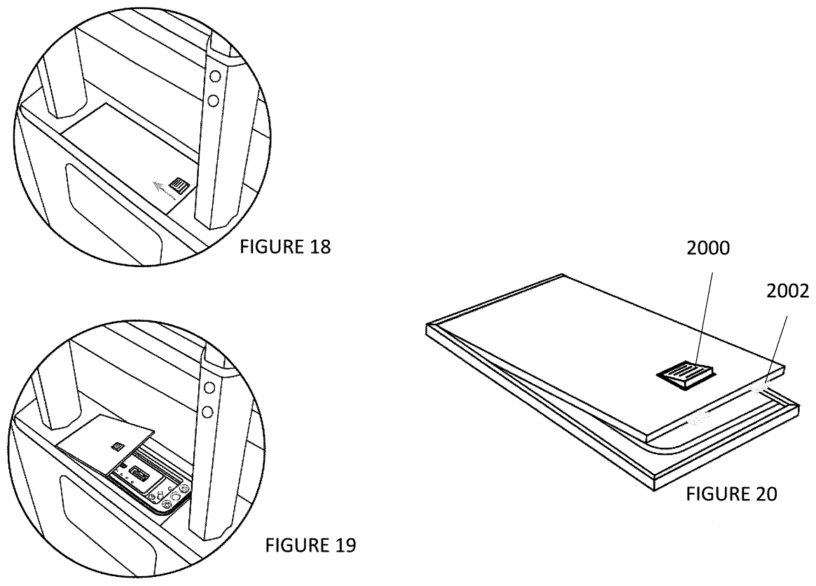

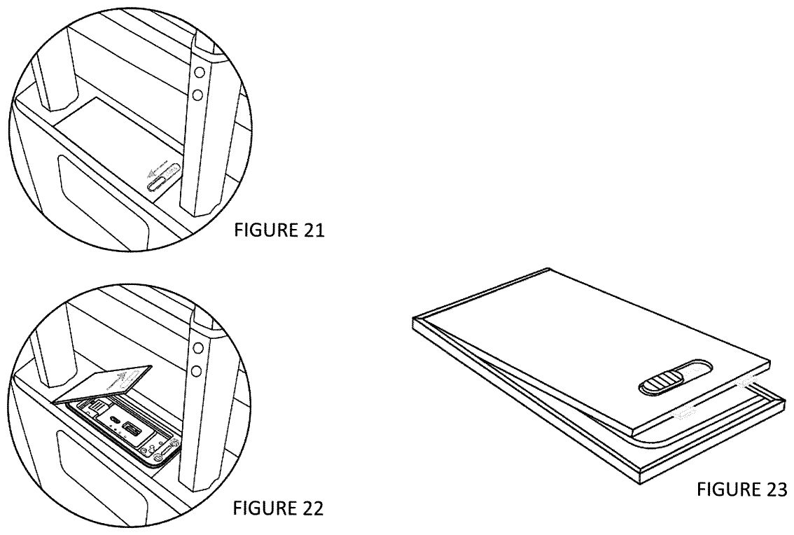

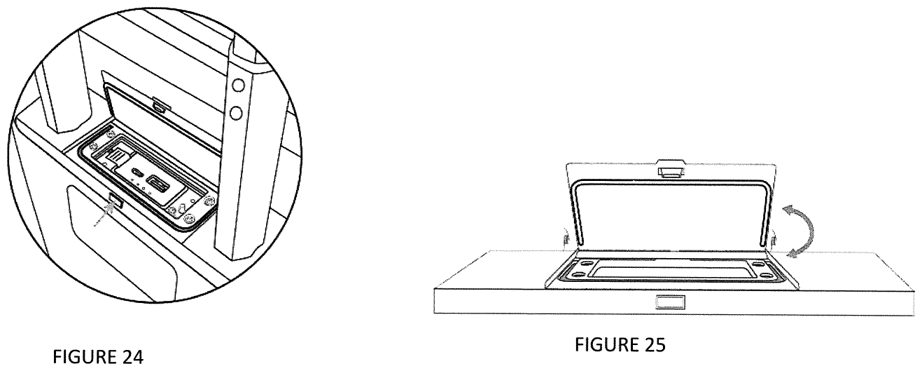

As shown in FIGS. 18, 19 and 20, the upper closing device is designed with a button (2000) that can be pressed up and down. When the button is pressed downward, the male part (2002) of component of a retractable tongue on the upper closing device retracts inward and the cover is opened by the spring built into the body. The upper closing device pops open under the force of the built-in spring in the body to open the upper closing device. When the button is pressed downward, the male part (2002) of component of retractable tongue on the upper closing device extends into the female part of component of corresponding slot in the body to achieve closure.

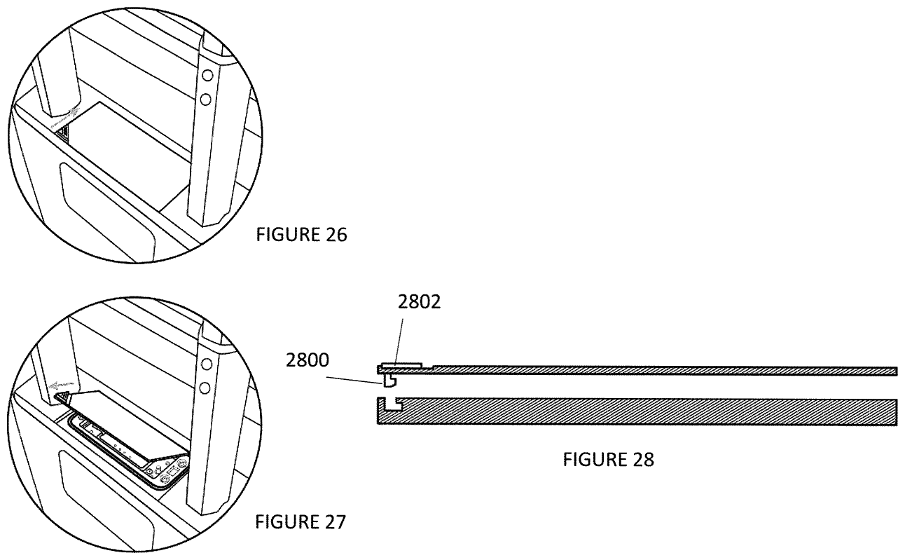

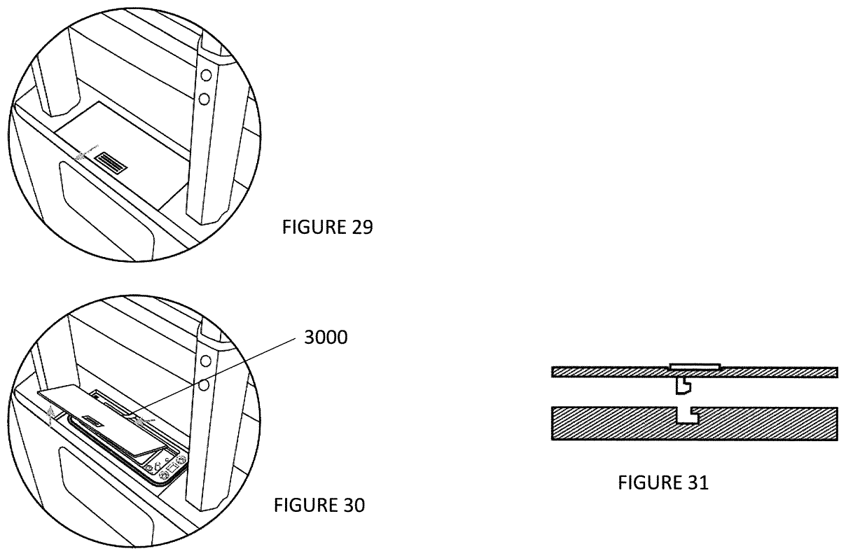

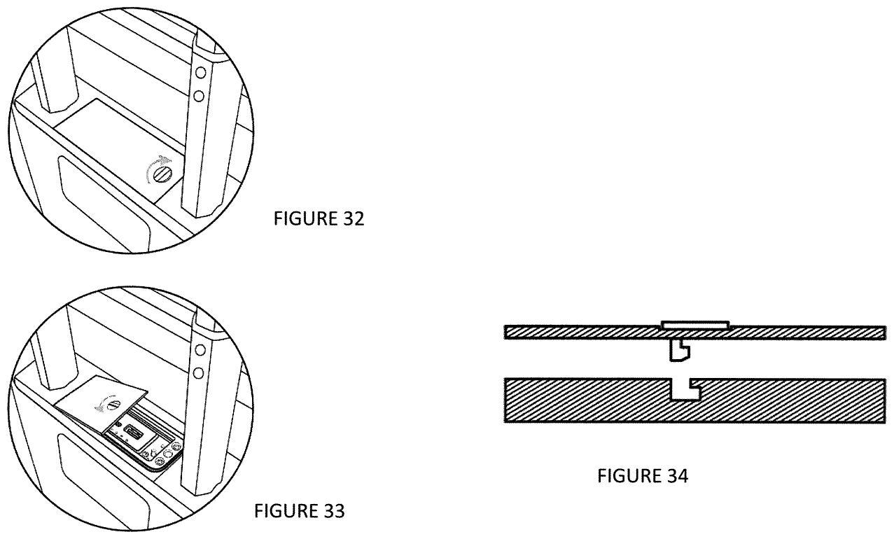

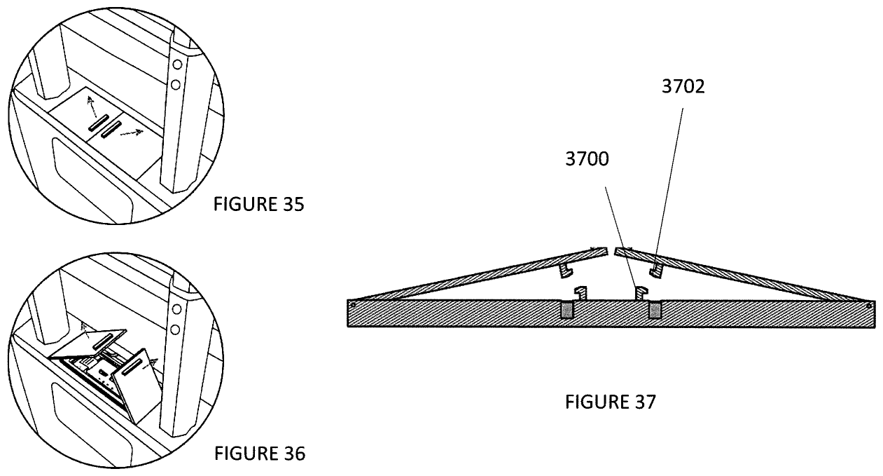

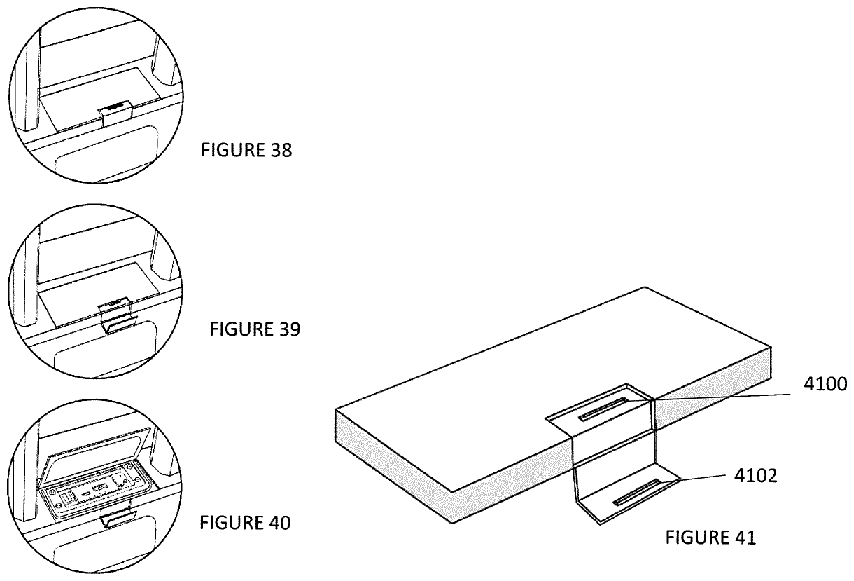

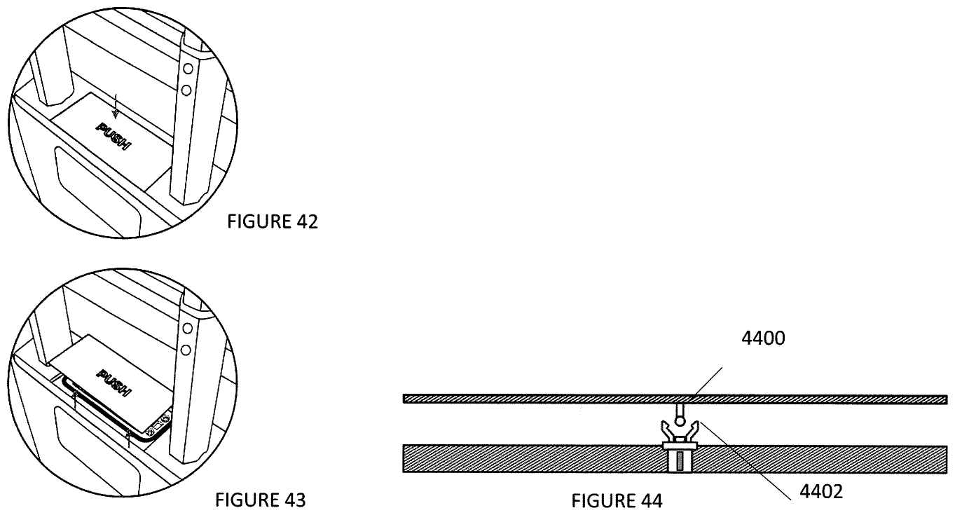

As shown in FIGS. 26, 27 and 28, the upper closing device is provided with an activity tongue male part with a protruding catch (2800) and a button (2802) to control the activity tongue. The upper part of the charger accommodating cavity body is also provided with a female part with a groove matching the activity tongue male part, and the activity tongue part is moved to a loose position or retracted the protruding catch or rotated the protruding catch by toggling or pulling the button, so that the male part can be fixed in the female part or released from the female part after operating the button.

As shown in FIG. 14, the upper part of the charger accommodating cavity body opening is designed with a female part of components i.e. a slotted opening, upper closing device is designed with a male part of components i.e. a retractable tongue. The upper closing device has a button, the button can be pulled upwards and when the button is pulled upwards, the male part of components retracts internally and the upper closing device can be opened or popped up, conversely, when the upper closing device is closed, the male part of component pops outward and tightly unites with the female part of component, and the button on the upper closing device returns to its original position. As shown in FIG. 37, a first male component (3700) moving inward or outward to hold or release a second male component (3702),

As shown in FIG. 41, the upper closing device has a female part component (4100) i.e. a slot, and on the upper part of the charger accommodating cavity body, there is a cover place corresponding to a movable L shaped with a male component (4102). When the L shaped cover plate is opened, the upper closing device automatically pops up, when stuck on the L shaped cover plate, it achieves a closed seal. As shown in FIG, 44, the male part (4400) on the upper closing device has a gripped catch and the female part (4402) on the upper part of the charger accommodating cavity body has a movable release and grip fastener and a spring-loaded control element that controls the release or grip of the fastener by pressing.

In accordance with a further aspect of the present development, as shown in FIGS. 45A-45E, the present development can further relate to a piece of luggage L with a customized cavity for containing an electronic object such as a multifunction electronic object. As shown in FIG. 45, an item of luggage L can include a body B with wheels W and a handle H. The handle H can comprise a pull rod frame FR provided as part of the body B and including one or more telescopic pull rods R (shown as first and second parallel pull rods R1,R2) to be grasped by a user to pull or push the body B across a floor or another support surface on the wheels W. The pull rod frame FR is connected to the body B and can include a customized accommodating cavity V that can be located adjacent the one or more pull rods R (R1,R2), In the illustrated example, the cavity V is located between the first and second parallel pull rods R1,R2 and can include an optional access cover CV that pivots or otherwise moves between a closed position where the access cover CV extends across and blocks an open top of the cavity V and an opened position where the access cover CV is pivoted or otherwise moved away from the open top of the cavity V to allow access to the cavity V.

The cavity V can comprise a case S1 installed in the cavity V and selectively removable from the cavity V (the case S1 is shown in an exploded view in FIG. 45 and selectively insertable/installable in the cavity V as indicated by the arrow A1). The case S1 can comprise one or more mounting flanges F or similar structure for being fastened to the pull rod frame FR or other part of the body B with screws or other fasteners (not shown) so as to be securely but releasably mounted in the cavity V. In a first embodiment as best shown in shown in the exploded views of FIGS. 45C-45E to reveal internal components, the case S1 comprises a multi-function system comprising a battery T (which can be replaceable and/or rechargeable) and at least one of (or all of) the following electronic chips or chip sets or systems CX: Find My (a crowdsourced wireless Bluetooth network) location chip; an ultra-wideband (UWB) location chip; a cellular communication chip/card such as a 4G card/SIM card; a global positioning satellite (GPS) chip; a MiFi (wireless router mobile hotspot) chip; a near field communication (NFC) wireless chip that can be used for authentication and/or payment. As best shown in FIGS. 45D-45E, the case S1 can include one or more chip bases CB installed on a printed circuit board PCB and the desired chips CX from the above listing can be installed in the corresponding chip base CB such that the installed chip CX is operatively electrically connected to the battery T and all associated components of the case S1. The battery T can be selectively removed from the case S1 and replaced and/or recharged. As noted, the case S1 is selectively installed in the cavity V as indicated by the arrow A1 and can be secured in the cavity V by fasteners installed through the mounting flange(s) For by a retaining clip or the like. The Find My chip CX and/or ultra-wideband (UWB) chip CX allow for wireless location functions to allow a user to track and locate the luggage L and also allow for separation reminder functions in case the user's mobile phone is not near the luggage L.

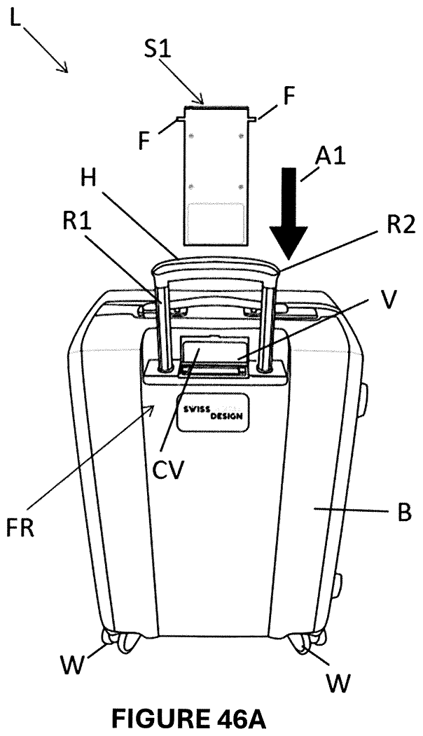

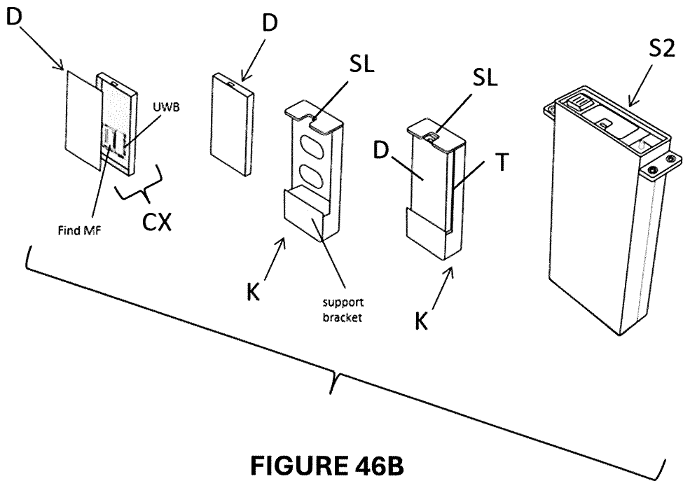

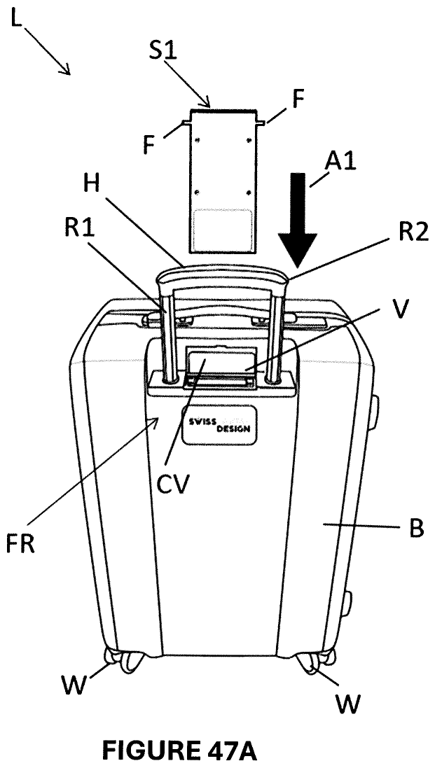

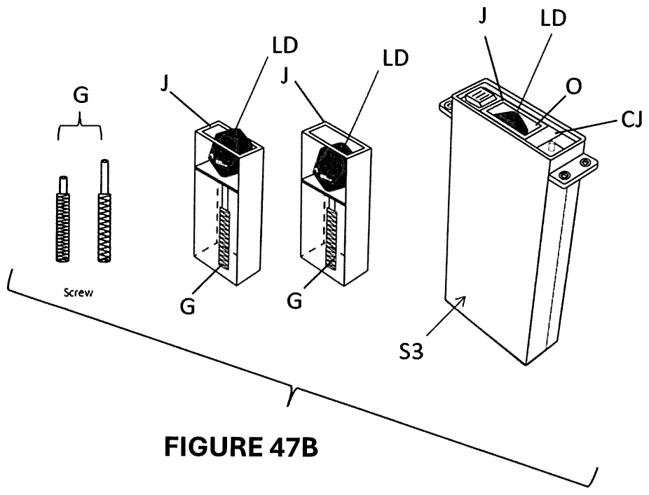

FIGS. 46A-46B show an alternative version of the case S2 that is the same as the case S1 except as otherwise shown and/or described. The luggage cavity V can comprise a case S2 installed in the cavity V and selectively removable from the cavity V (the case S2 is shown in an exploded view in FIG. 46B and selectively insertable/installable in the cavity V as indicated by the arrow A1). The case S2 can include a support bracket K that supports the battery T. The bracket K includes a slot SL that is configured to receive and retain a multi-function cartridge D that can comprise any one or all of the following chips or chip sets or systems CX: Find My (a crowdsourced wireless Bluetooth network) location chip; an ultra-wideband (UWB) location chip; a cellular communication chip/card such as a 4G card/SIM card; a global positioning satellite (GPS) chip; a MiFi (wireless router mobile hotspot) chip; a near field communication (NFC) wireless chip for authentication and/or payments. When the cartridge D is installed in the slot SL and mated with the bracket K, the cartridge D is operatively electrically connected to the battery to receive power. The cartridge D can be customized to include any one or all of the above-listed chips/chip sets CX depending upon the functions desired by the user. In one example, the cartridge D comprises a Find My (a crowdsourced wireless Bluetooth network) locator chip and/or an ultra-wideband (UWB) locator chip to allow for wireless location functions to allow a user to track and locate the luggage L and also allow for separation reminder functions in case the user's mobile phone is not near the luggage L. As with the case S1, the case S2 is selectively connected to the luggage body B by selective installation in the cavity V as indicated by the arrow A1.

FIGS. 47A-47B shows an alternative version of the case S3 that is the same as the case S1 except as otherwise shown and/or described. The luggage cavity V can comprise a case S3 installed in the cavity V and selectively removable from the cavity V (the case S3 is shown in an exploded view in FIG. 47B and selectively insertable/installable in the cavity V as indicated by the arrow A1). The case S3 can be secured to the luggage body B in the cavity V using a screw G as shown. The case S3 includes a device receiving region or recess J that is adapted to receive and retain a position locating device such as an Apple Air Tag and/or other wireless position locating device LD such as the SWISSDIGITAL brand Hexagon Bluetooth locator device and/or an ultra-wideband (UWB) wireless locator device and/or a GPS chip device. The case S3 can include a cover CJ that can close the device receiving region/recess J and capture the locating device LD in the receiving region/recess J. The cover CJ can include a window or opening O so a user can look into the receiving region/recess J to visualize if the locating device LD is present in the receiving region/recess J. In this case, the locating device LD can include its own self-contained battery and/or can be powered by a battery T that is part of the case S3 in a wired or wireless manner. The locating device LD comprises a Find My (a crowdsourced wireless Bluetooth network) locator chip and/or an ultra-wideband (UWB) locator chip to allow for wireless location functions to allow a user to track and locate the luggage L and also allow for separation reminder functions in case the user's mobile phone is not near the luggage. The locating device LD can also include other functionality such as NFC authentication or payment capabilities.

The preferred embodiment above has further explained in detail the purpose, technical scheme and advantages of the present invention. It should be understood that the said embodiment is only a preferred embodiment of the present invention and is not intended to limit the present invention. Any modification, equivalent substitution, improvement, etc. made within the spirit and principles of the present invention should be included in the scope of protection of the present invention.

1. A bag, comprising:
a body;
a pull rod frame mounted on a portion of the body, the pull rod frame comprising first and second pull rods;
a cavity within the body.

2. The bag of claim 1, further comprising:
a case configured to fit within the cavity and be selectively removable from the cavity.

3. The bag of claim 2, wherein the case includes:
at least one flange configured to be fastened to the pull rod frame or a portion of the body.

4. The bag of claim 2, wherein the case further comprises:
a battery; and
at least one electronic chip connected to the battery.

5. The bag of claim 4, wherein the battery is selectively removable from the case.

6. The bag of claim 4, wherein the case includes a support bracket configured to support the battery.

7. The bag of claim 6, wherein the support bracket includes a slot configured to receive and retain a cartridge comprising the at least one electronic chip.

8. The bag of claim 7, wherein the cartridge is connected to the battery.

9. The bag of claim 4, wherein the at least one electronic chip comprises:
a crowdsourced wireless Bluetooth network location chip;
an ultra-wideband (UWB) location chip;
a cellular communication chip;
a global positioning satellite (GPS) chip;
a MiFi (wireless router mobile hotspot) chip; and
a near field communication (NFC) wireless chip.

10. The bag of claim 4, wherein the case further comprises at least one chip base on which the at least one electronic chip is installed.

11. The bag of claim 2, wherein the case further includes a recess configured to receive an associated position locating device.

12. The bag of claim 11, further comprising a cover configured to cover the case when installed in the cavity.

13. The bag of claim 12, wherein the cover includes a window overlaying the associated position locating device.

14. A piece of luggage, comprising:
a body;
a pull rod frame mounted on a portion of the body, the pull rod frame comprising first and second pull rods;
a cavity within the body; and
a case configured to fit within the cavity and be selectively removable from the cavity.

15. The piece of luggage of claim 14, wherein the case further comprises:
a battery; and
at least one electronic chip connected to the battery.

16. The piece of luggage of claim 15, wherein the case includes a support bracket configured to support the battery.

17. The piece of luggage of claim 16, wherein the support bracket includes a slot configured to receive and retain a cartridge comprising the at least one electronic chip.

18. The piece of luggage of claim 15, wherein the at least one electronic chip comprises:
a crowdsourced wireless Bluetooth network location chip;
an ultra-wideband (UWB) location chip;
a cellular communication chip;
a global positioning satellite (GPS) chip;
a MiFi (wireless router mobile hotspot) chip; and
a near field communication (NFC) wireless chip.

19. The piece of luggage of claim 15, wherein the case further comprises at least one chip base on which the at least one electronic chip is installed.

20. The piece of luggage of claim 14, wherein the case further includes a recess configured to receive an associated position locating device.
